(19) United States
(12) Patent Application Publication
(10) Pub. No.: US 2019/0382536 A1
(43) Pub. Date: Dec. 19, 2019

(54) BINDER COMPRISING REACTION PRODUCTS OF POLYGLYCEROL AND ACID

(71) Applicant: CARGILL, INCORPORATED, Wayzata, MN (US)

(72) Inventor: Kioh HWANG, Cedar Rapids, IA (US)

(73) Assignee: CARGILL, INCORPORATED, Wayzata, MN (US)

(21) Appl. No.: 16/480,617

(22) PCT Filed: Jan. 24, 2018
(86) PCT No.: PCT/US2018/014966

§ 371 Date: Jul. 24, 2019

Related U.S. Application Data
(60) Provisional application No. 62/449,948, filed on Jan. 24, 2017.

(51) Int. Cl. C08G 81/02; C08J 5/10; C08K 3/32

(52) U.S. Cl. CPC C08G 81/025; C08K 3/32; C08J 5/10

(57) ABSTRACT

Binder compositions for use in the formation of fiber insulation and nonwoven mats are provided comprising water and a reaction product of a) a polymeric poly(carboxylic acid) component and b) a polyglycerol component. In this composition, the dry weight ratio of poly(carboxylic acid) to polyglycerol is from about 70:30 to about 40:60, the binder composition comprises no more than about 25% by weight of sugar-containing components based on non-water ingredients of the binder composition, and the polyglycerol component comprises no more than about 15% by weight of monoglycerol based on non-water ingredients of the polyglycerol component. Products comprising a plurality of randomly oriented fibers and the binder compositions are also described.

### FIELD

The present invention relates to aqueous binder compositions. More specifically, the present invention relates to aqueous binder compositions for use in the formation of insulation and nonwoven mats.

### BACKGROUND

Conventional fibers are useful in a variety of applications including reinforcements, textiles, and acoustical and thermal insulation materials. Although mineral fibers (e.g., glass fibers) are typically used in insulation products and nonwoven mats, depending on the particular application, organic fibers such as polypropylene, polyester, and multi-component fibers may be used alone or in combination with mineral fibers in forming the insulation product or nonwoven mat.

Certain fibrous insulation is typically manufactured by fiberizing a molten composition of polymer, glass, or other mineral and spinning fine fibers from a fiberizing apparatus, such as a rotating spinner. To form an insulation product, fibers produced by the rotating spinner are drawn downwardly from the spinner towards a conveyor by a blower. As the fibers move downward, a binder material is sprayed onto the fibers and the fibers are collected into a high loft, continuous blanket on the conveyor. The binder material gives the insulation product resiliency for recovery after packaging and provides stiffness and handleability so that the insulation product can be handled and applied as needed in the insulation cavities of buildings. The binder composition also provides protection to the fibers from interfilament abrasion and promotes compatibility between the individual fibers.

The blanket containing the binder-coated fibers is then passed through a curing oven and the binder is cured to set the blanket to a desired thickness. After the binder has cured, the fiber insulation may be cut into lengths to form individual insulation products, and the insulation products may be packaged for shipping to customer locations. One typical insulation product produced is an insulation batt or blanket, which is suitable for use as wall insulation in residential dwellings or as insulation in the attic and floor insulation cavities in buildings.

Nonwoven mats may be formed by conventional wet-laid processes. For example, wet chopped fibers are dispersed in a water slurry that contains surfactants, viscosity modifiers, defoaming agents, and/or other chemical agents. The slurry containing the chopped fibers is then agitated so that the fibers become dispersed throughout the slurry. The slurry containing the fibers is deposited onto a moving screen where a substantial portion of the water is removed to form a web. A binder is then applied, and the resulting mat is dried to remove any remaining water and cure the binder. The formed nonwoven mat is an assembly of dispersed, individual glass filaments.

Binder compositions are described, for example, in U.S. Pat. Nos. 6,331,350 and 6,933,349.

### SUMMARY

Binders for use in the formation of fiber insulation and nonwoven mats have been prepared by esterification of poly carboxylic acids with low molecular weight polyols. However, the use of low molecular weight polyols in binder compositions may result in emission of unreacted monomer during the curing process, causing multiple issues for health as well as environment. Unreacted polyols present in a cured binder system tends to emit to the air slowly as well. Using high molecular weight polyols instead, such as syrup, dextrin, maltodextrin, and starch, leads to different problems, because such polyols are difficult to handle in process due to high viscosity as well as exhibiting biological instability in aqueous solution. Such a carbohydrate based binder composition also tends to show instability to the heat.

It has been found that a very advantageous binder composition for use in the formation of fiber insulation and nonwoven mats is provided comprising water and a reaction product of a) a polymeric poly(carboxylic acid) component and b) a polyglycerol component. In this composition, the dry weight ratio of poly(carboxylic acid) to polyglycerol is from about 70:30 to about 40:60, the binder composition comprises no more than about 25% by weight of sugar-containing components based on non-water ingredients of the binder composition, and the polyglycerol component comprises no more than about 15% by weight of monoglycerol based on non-water ingredients of the polyglycerol component.

In an aspect, the binder composition advantageously is formaldehyde free. In an aspect, the binder composition advantageously has a high renewable content. In an aspect, the binder composition advantageously is easy to handle, exhibiting low viscosity as compared to maltodextrin and/or starch based binders and does not stick to equipment during processing steps. In an aspect, the binder composition advantageously is more stable (i.e. does not decompose) as compared to carbohydrate based binders. In an aspect, the binder composition advantageously exhibits excellent film formation. In an aspect, the binder composition advantageously is exhibits excellent tensile strength at both room temperature and 100° C. In an aspect, the binder composition advantageously is exhibits excellent tensile strength under high humidity and washing conditions. In an aspect, the binder composition advantageously is exhibits excellent color stability over time. In an aspect, the binder composition advantageously exhibits excellent low emissions of volatile organic compounds.

### BRIEF DESCRIPTION OF THE DRAWINGS

The accompanying drawings, which are incorporated in and constitute a part of this application, illustrate several aspects of the invention and together with a description of the embodiments serve to explain the principles of the invention. A brief description of the drawings is as follows:

FIG. 1 is a FIG. 1 is a GC chromatogram of an aspect of polyglycerol used to form an aspect of the present binder.

### DETAILED DESCRIPTION

The aspects of the present invention described below are not intended to be exhaustive or to limit the invention to the precise forms disclosed in the following detailed description. Rather a purpose of the aspects chosen and described is by way of illustration or example, so that the appreciation and understanding by others skilled in the art of the general principles and practices of the present invention can be facilitated.

The Polymeric Poly(Carboxylic Acid) Component

In the present binder composition, the polymeric poly(carboxylic acid) component is an organic polymer or oligomer containing more than one pendant carboxy group. The polycarboxy polymer may be a homopolymer or copolymer prepared from unsaturated carboxylic acids including but not necessarily limited to, acrylic acid, methacrylic acid, crotonic acid, isocrotonic acid, maleic acid, cinnamic acid, 2-methylmaleic acid, itaconic acid, 2-methylitaconic acid, α,β-methyleneglutaric acid, and the like. Alternatively, the polycarboxy polymer may be prepared from unsaturated anhydrides including, but not necessarily limited to, maleic anhydride, methacrylic anhydride, and the like, as well as mixtures thereof. Methods for polymerizing these acids and anhydrides are well-known in the chemical art. It should be noted that these polycarboxy polymers are polymerized by reaction of the unsaturated groups, so that the majority of curing of the poly(carboxylic acid) component with polyol will take place through esterification.

The polymeric poly(carboxylic acid) component may additionally comprise a copolymer of one or more of the aforementioned unsaturated carboxylic acids or anhydrides and one or more vinyl compounds including, but not necessarily limited to, styrene, α-ethylstyrene, acrylonitrile, methacrylonitrile, methyl acrylate, ethyl acrylate, n-butyl acrylate, isobutyl acrylate, methyl methacrylate, n-butyl methacrylate, isobutyl methacrylate, glycidyl methacrylate, vinyl methyl ether, vinyl acetate, and the like. Methods for preparing these copolymers are well-known in the art.

In an aspect, the polymeric poly(carboxylic acid) component comprises homopolymers and copolymers of polyacrylic acid. It is particularly preferred that the molecular weight of the poly(carboxylic acid) component, and in particular polyacrylic acid polymer, is less than 10000, more preferably less than 5000, and most preferably about 3000 or less, with about 2000 being advantageous.

In an aspect, the polymeric poly(carboxylic acid) component comprises a poly(carboxylic acid) selected from the group consisting of one or more of polyacrylic acid, polymethacrylic acid, and polyitaconic acid. In an aspect, the poly(carboxylic acid) component comprises polyacrylic acid. In an aspect, the poly(carboxylic acid) component comprises polyacrylic acid having an average molecular weight of from about 1000 to about 15000; or polyacrylic acid having an average molecular weight of from about 2000 to about 12000. In an aspect, the poly(carboxylic acid) component comprises polymethacrylic acid. In an aspect, the poly(carboxylic acid) component comprises polymethacrylic acid having an average molecular weight of from about 1000 to about 15000; or polymethacrylic acid having an average molecular weight of from about 2000 to about 12000. In an aspect, the poly(carboxylic acid) component comprises polyitaconic acid. In an aspect, the poly(carboxylic acid) component comprises polyitaconic acid having an average molecular weight of from about 2000 to about 20000; or polyitaconic acid having an average molecular weight of from about 5000 to about 12000.

The Polyglycerol Component

Polyglycerols are prepared by reacting monoglycerol (also known as “glycerin”) under conditions to cause condensation of two or more glycerol molecules. See, for example, U.S. Pat. No. 6,620,904. This reaction produces a glycerol component comprising a distribution of glycerol based compounds containing various numbers of glycerol units, e.g. diglycerol, triglycerol, tetraglycerol, pentaglycerol, and so forth. The reaction is carried out under reaction conditions to provide the desired distribution of glycerol based compounds in the intermediate Polyglycerol Component as described herein. Cyclic polyglycerols may also be produced, which are polyglycerol compounds where two glycerols in the polyglycerol compound have reacted together form a ring. For purposes of the present disclosure, a “dicyclic” polyglycerol is a diglycerol wherein two glycerols in the polyglycerol compound have reacted together form a ring (i.e. this means that the polyglycerol contains two glycerols in the compound and contains cyclic structure. This does not mean that the compound contains two cyclic structures). For purposes of the present disclosure, a “tricyclic” polyglycerol is a triglycerol wherein two glycerols in the polyglycerol compound have reacted together form a ring (i.e. this means that the polyglycerol contains three glycerols in the compound and contains at least one cyclic structure. This does not mean that the compound contains three cyclic structures). It will be appreciated that the glycerols that react to form the ring are not necessarily adjacent to each other in the polyglycerol compound. The dicyclic and tricyclic polyglycerol compounds are distinguishable from diglycerol and triglycerol compounds that do not contain cyclic functionality by GC analysis. Therefore, dicyclic and tricyclic polyglycerol compounds are not counted in the total amount of diglycerol and triglycerol compounds when reporting relative amounts of polyglycerol components in polyglycerol compositions in the present disclosure.

In preparation of the polyglycerol, a residual amount of monoglycerol will likely if not always be present. For purposes of the present invention, any monoglycerol present in the binder composition will by definition be considered part of the polyglycerol component. In an aspect, the polyglycerol component comprises no more than about 15% by weight of monoglycerol based on non-water ingredients of the polyglycerol component (i.e. all glycerol based compounds present in the binder composition). In an aspect, the polyglycerol component comprises no more than about 10% or 5% or 2%, or 1% or 0.5% by weight of monoglycerol. This low amount of monoglycerol can be achieved by control of the reaction process to provide an intermediate Polyglycerol Component with the desired low monoglycerol content. In an aspect, the desired low amount of monoglycerol can be achieved by performing an additional step of removal of the monoglycerol by further separation processes, such as distillation or wiped film evaporator (“WFE”) techniques.

It has been found that the distribution of glycerol based compounds containing various numbers of glycerol units significantly affects the properties of the resulting binder compositions. In an aspect, the polyglycerol component has a triglycerol content of from about 15% to about 30% by weight. In an aspect, the polyglycerol component has a combined triglycerol and tetraglycerol content of less than about 70%; or a combined triglycerol and tetraglycerol content of less than about 50%; or a combined triglycerol and tetraglycerol content of less than about 40%; or a combined triglycerol and tetraglycerol content of less than about 35%; or a combined triglycerol and tetraglycerol content of less than about 25%. In an aspect, the polyglycerol component has a combined triglycerol and tetraglycerol content of from about 20% to about 50%.

In an aspect, the polyglycerol component has a combined triglycerol and higher polyglycerol oligomer content of from about 50% to about 95%. This aspect has been found to in particular provide binder compositions having excellent tensile strength and high humidity performance properties. In an aspect, the polyglycerol component has a combined triglycerol and higher polyglycerol oligomer content of from about 60% to about 95%. In an aspect, the polyglycerol component has a combined triglycerol and higher polyglycerol oligomer content of from about 70% to about 95%. In an aspect, the polyglycerol component has a combined tetraglycerol and pentaglycerol oligomer content of from about 50% to about 95%, and a triglycerol content of less than 12%. In an aspect, the polyglycerol component has a combined dicyclic and tricyclic content of at least 5%. In an aspect, the polyglycerol component has a combined dicyclic and tricyclic content of at least 15%. In an aspect, the polyglycerol component has a combined dicyclic and tricyclic content of at least 18%.

Ratio of Poly(Carboxylic Acid) to Polyglycerol

The dry weight ratio of poly(carboxylic acid) to polyglycerol in the aqueous binder composition is from about 70:30 to about 40:60. In an aspect, the molar ratio of OH/CO₂H is from about 0.6 to about 2. In an aspect, the molar ratio of OH/CO₂H is from about 0.6 to about 1.4, or from about 0.6 to about 1.3. In an aspect, the dry weight ratio of poly(carboxylic acid) to the polyglycerol component is from about 65:45 to about 40:60. In an aspect, the dry weight ratio of poly(carboxylic acid) to the polyglycerol component is from about 50:50 to about 40:60.

Sugar-Containing Components
It has been found that incorporation of sugar-containing components in large amounts adversely affects the stability of the binder composition in storage and/or in the finished product, particularly under high humidity conditions. The binder composition therefore comprises no more than about 25% by weight of sugar-containing components based on non-water ingredients of the binder composition. In an aspect, the binder composition comprises no more than about 20%, or no more than about 15%, or no more than about 10% or no more than about 5% by weight of sugar-containing components based on non-water ingredients of the binder composition. Examples of sugar-containing components including sugar monomers (such as glucose, fructose, or galactose) and oligomers or polymers comprising sugar monomer units (such as starch, glucan, dextrin and maltodextrin).

Solids Content

It has been found that the solids content of the binder composition can significantly affect the properties of the resulting binder compositions. In an aspect the aqueous binder composition has a dry solids (“DS”) content of from about 30 to 75% by weight.

Viscosity

It has been found that the viscosity of the binder composition can significantly affect the properties of the resulting binder compositions. In an aspect the aqueous binder composition has a viscosity of from 40 cp to 3000 cp at 55% DS at 25° C. Viscosity is using a Brookfield RV DV-II+ viscometer at the 100 rpm, using a spindle #2 through #5 depending on the sample viscosity. A sample in a 500 mL beaker was used for the test at 25° C., unless specified.

In an aspect, the binder composition has a viscosity of from 5 cp to 2000 cp at 55% DS at 25° C. In an aspect, the binder composition has a viscosity of from 30 cp to 1000 cp at 55% DS at 25° C. In an aspect, the binder composition has a viscosity of from 50 cp to 500 cp at 55% DS at 25° C. It has been found that compositions exhibiting the desired viscosity range throughout the cure process advantageously readily cure to a satisfactory degree as compared to binder compositions that exhibit a viscosity above the desired viscosity range during the cure process.

Tackiness

It has been found that the tackiness of the binder composition can significantly affect the handling properties of the binder compositions during manufacture of nonwoven fibrous web comprising a binder composition, and in performance of the final cured product. In particular, binder compositions that are too tacky do not flow uniformly to the desired web fiber intersections in the mat before or during cure, and therefor result in product weaknesses or irregularities.

Optional Additional Components

The binder composition may optionally comprise additional components, such as a monomeric acid or salts thereof in an amount of about 10% by weight or less. In an aspect, the monomeric acid is selected from the group consisting of citric acid, dicarboxylic acids, such as maleic acid, malic acid, succinic acid, cinnamic acid, adipic acid, phosphoric acid, trifluoromethanesulfonic acid and their analogs. In an aspect, the salt of the monomeric acids is an inorganic salt, such as salts where the counterion is selected from sodium, potassium or calcium. In an aspect, the composition may comprise a cure accelerator. Examples of accelerators include the sulfur containing acids or salts thereof and the phosphorus containing acids or salts thereof. Further examples of accelerators include the alkali metal salts of phosphorous acid, hypophosphorous acid, polyphosphoric acids, sulfurous acid, hyposulfurous acid, and sulfuric acid. Non-limiting examples of such salts are sodium hypophosphite, sodium phosphite, potassium phosphite, disodium pyrophosphate, tetrasodium pyrophosphate, sodium tripolyphosphate, sodium hexametaphosphate, potassium phosphate, potassium polymetaphosphate, potassium polyphosphate, potassium tripolyphosphate, sodium trimetaphosphate, sodium tetrametaphosphate, and the analogous sulfur compounds. Mixtures of two or more of such salts can also be used. Particularly preferred cure accelerators are sodium hypophosphite, sodium phosphite, and mixtures thereof. In an aspect, the cure accelerator may be present in the binder composition in an amount of from about 1% to about 15% by weight based on total solids content. While not being bound by theory, it is believed that certain accelerator compounds, such as the sulfur containing acids or salts thereof and the phosphorus containing acids or salts thereof, may act both as accelerators and crosslinking agents.

Advantageously, the binder composition may be provided that is expressly free of certain particularly undesirable chemicals. In an aspect, the aqueous binder composition is substantially free of formaldehyde.

In use, the aqueous binder composition may be shipped and stored in a concentrated composition that is diluted to a suitable solids content for application to fibers. In an aspect, the aqueous binder composition has a DS content of from about 30 to 75% by weight. In an aspect, the aqueous binder composition is diluted before application to fibers to a DS content of from about 10 to 30%.

In an aspect, the composition is stored or shipped as a one part composition (i.e. all ingredients of the binder composition are provided in a single container) before being applied to a fiber. In an aspect, the separate components may be shipped separately as a multi-part composition that is mixed together at the fiber insulation and/or nonwoven mat manufacturing site.

Final Products

The above described binder composition is used to prepare a fibrous insulation product comprising a plurality of randomly oriented fibers. In an aspect, fibers are randomly oriented, the binder composition is applied to at least a portion of the fibers and caused to cure to form a fibrous insulation product. The resulting product is a fibrous insulation product comprising a plurality of randomly oriented fibers; and a binder applied to at least a portion of the fibers, said binder comprising the reaction product of the binder composition.

In an aspect, above described binder composition is used to prepare nonwoven products where the fibers of the product are inorganic fibers. In an aspect, the inorganic fibers are fiberglass fibers that are silica materials which are formed through an extrusion process. In an aspect, the inorganic fibers are mineral fibers can be prepared from various silicate based inorganic raw materials using a process in which the raw material in molten form is “blown” or “spun” into fibers. These products are commonly referred to as “mineral wool”, which is a generic term for various mineral fibrous materials commonly known as “rock wool”, “slag wool” and “glass wool.” Rock wool is made from natural rock or combinations of natural minerals; slag wool is derived from iron, copper or lead blast furnace slag; and glass wool is made from conventional glass batch materials such as silica, sand, soda ash or borax, dolomite, and minor ingredients. Such materials are described, for example, in U.S. Pat. No. 4,532,006. In an aspect, the inorganic fibers have a diameter of about 2 to 9 microns and a length of about ¼ to 3 inches.

Likewise, the above described binder composition is used to prepare a nonwoven mat comprising a plurality of randomly oriented fibers. In an aspect, fibers are randomly oriented, the binder composition is applied to at least a portion of the fibers and caused to cure to form a nonwoven mat. The resulting product is a nonwoven mat product comprising a plurality of randomly oriented fibers; and a binder applied to at least a portion of the fibers, said binder comprising the reaction product of the binder composition.

In an aspect, the final product is a nonwoven fibrous web comprising a binder composition so that the product has a density of from about 16 to about 300 Kg/m³. Such products are commonly referred to as a “high density” product. Examples of such high density products include ceiling tiles, pipe wrapping, oven insulator materials, and like products.

In an aspect, the final product is a nonwoven fibrous web comprising a binder composition so that the product has a density of about less than 16 Kg/cm³. Such products are commonly referred to as a “low density” product. Examples of such low density products include batt insulation.

In an aspect, the final nonwoven fibrous web product is prepared by randomly orienting a plurality of fibers, applying a binder to at least a portion of the fibers to form an intermediate web product, and curing the binder by exposure of the intermediate web product to heat and optionally pressure for a time sufficient to cure the binder. In an aspect, the intermediate web product is cured in a curing process at a temperature of from about 120 to 150° C. for a time of from about 10 to 90 minutes. In an aspect, the intermediate web product is cured in a multiple step curing process, such as by cure in a first curing process at a temperature of from about 120 to 150° C. for a time of from about 10 to 20 minutes, followed by a second curing process at a temperature of from about 120 to 150° C. for a time of from about 40 to 90 minutes until no notable weight change of a sample observed.

In an aspect, fiber insulation and nonwoven mats prepared using the present binder compositions exhibit excellent performance characteristics even after having been exposed to 100% RH humidity for a time of 20 minutes. In an aspect, fiber insulation and nonwoven mats prepared using the present binder compositions exhibit excellent performance characteristics even after having been exposed to 100% RH humidity for a time of 20 minutes, provided that the product is permitted to equilibrate to a 30% RH for a time of 20 minutes. While not being bound by theory, it is believed that such products tend to “self heal” or otherwise recover tensile strength properties that are temporarily adversely affected by high humidity.

### Examples

I. Glycerin Sources

USP Glycerin is glycerol that satisfies United States Pharmacopeia (USP) requirements. USP Glycerin is readily commercially available.

Biodiesel Sourced Glycerin/glycerin acetate is obtained from a commercial biodiesel process that utilizes acetic acid in the neutralization step. Further, the glycerin/glycerin acetate product used in these examples has been partly refined to attain high glycerin and low free acetic acid. This process results in a composition that comprises a significant level of glycerol-containing compounds comprising acetate ester moieties. Biodiesel derived “crude glycerol” and uses to make polyglycerol are discussed in U.S. Pat. No. 8,816,133 and EP 0719752. However, the present Biodiesel Sourced Glycerin/Glycerin Acetate is a specific type of crude glycerin due to the presence of glycerin acetate. In an aspect, the present Biodiesel Sourced Glycerin/Glycerin Acetate comprises from about 94 wt % to about 99.8 glycerin, from about 0.1 wt % to about 5 wt % glycerin acetate, and from about 0 wt % to about 1% wt % free acetic acid determined by the AOCS methods Cd3-25, 3d-63, and ASTM D6584.

In an aspect, the Biodiesel Sourced Glycerin/Glycerin Acetate composition may be partially purified, so that it contains no more than 5% acetic acid, contains no more than 0.02% inorganic salt, and/or contains no more than 7% fatty acid.

The Biodiesel Sourced Glycerin/Glycerin Acetate used in the present Examples comprised 95% glycerin, 2.15% glycerin acetate, and 0.3% free acetic acid.

II Polyglycerol Component Syntheses

A number of polyglycerol components were prepared having a distribution of glycerol based compounds containing various numbers of glycerol units. The polyglycerol components prepared, and the distribution of glycerol based compounds in these components as determined by GC as described below are presented in Table 1 below:

TABLE 1

| Components | Polyglycerol | Polyglycerol | Polyglycerol | Polyglycerol | Polyglycerol | Polyglycerol |
|---|---|---|---|---|---|---|
| (%) | A | B | C | D | E | F |
| gly | 32.0% | 10.3% | 2.9% | 1.2% | 0.7% | 3.5% |
| dicyclic | 2.9% | 5.0% | 3.2% | 9.2% | 26.0% | 12.9% |
| di- | 29.7% | 16.5% | 22.4% | 8.3% | 3.7% | 7.9% |
| tricyclic | 1.5% | 3.0% | 3.7% | 9.6% | 12.5% | 7.1% |
| tri- | 16.8% | 15.5% | 17.6% | 10.4% | 5.8% | 9.7% |
| tetra- | 6.0% | 17.0% | 15.4% | 15.0% | 16.1% | 14.0% |
| penta- | 6.0% | 17.7% | 11.3% | 14.0% | 13.9% | 11.8% |
| hexa- | 2.7% | 8.0% | 8.3% | 11.4% | 12.5% | 9.5% |
| hepta- + | 2.5% | 7.0% | 15.0% | 20.9% | 8.8% | 23.6% |
| Sum | 100% | 100% | 100% | 100% | 100.0% | 100.0% |

The specific manner of preparing these polyglycerol components is described as follows:

Polyglycerol A:

98.5% USP glycerin, 1% adipic acid, and 0.5% potassium hydroxide are added to a reactor that was set up with a nitrogen sparge, agitation and a distillation condenser. The reactor is heated to 230° C. with nitrogen sparge. Once 230° C. is reached, the nitrogen sparge is shut off and the reactor is gradually brought down to 250 Torr at a rate of about 75 Torr per hour. When 250 Torr is reached, the reaction is monitored via GC until the glycerin content is between 27% and 33%. Once the desired glycerin content of the polyglycerol component is reached, the vacuum is stopped and the reactor is re-pressurized under nitrogen and the reactor is cooled.

Polyglycerol B:

Polyglycerol A is heated to 230° C. under nitrogen sparge. Once the composition reaches a temperature of 230° C., the nitrogen sparge is shut off and a vacuum of 230 Torr is applied. The reaction is monitored via GC until a polyglycerol distribution is achieved wherein amount of polyglycerol compound comprising four or more glycerol units (i.e. tetramer and above) is greater than 50% relative to the total glycerol based compounds, and no glycerol based compounds of the same molecular weight may be present as more than 50% of the total glycerol based compounds. Once this is achieved, typically when the polyglycerol component has a glycerin content below 10%, the vacuum is stopped and the reactor is depressurized under nitrogen and the reactor is cooled.

Polyglycerol C:

Polyglycerol A is heated to 230° C. under nitrogen sparge. Once it reached 230° C. nitrogen sparge is shut off and 3 Torr of vacuum is applied to strip out the glycerin. The reaction is monitored via GC until the glycerin content of the polyglycerol component is below 4%. Once the glycerin content of the polyglycerol component is less than 4% the vacuum is stopped and the reactor is re-pressurized under nitrogen and the reactor is cooled.

Polyglycerol D:

Biodiesel Sourced Glycerin/Glycerin Acetate is loaded into a reactor with a 1.05:1 molar equivalent of potassium hydroxide to acetic acid/ester based on saponification value. The reactor was set up with a nitrogen sparge, agitation and a distillation condenser. The reactor is heated to 230° C. with nitrogen sparge. Once 230° C. is reached, the nitrogen sparge is shut off and the reactor is gradually brought down to 250 Torr at a rate of about 75 Torr per hour. When 250 Torr is reached, the reaction is monitored via GC until the glycerin content of the polyglycerol component is between 27% and 33%. Then vacuum is walked down to 100 Torr at a rate of 20 Torr per hour. The reactor pressure is held at 100 Torr until the glycerin content as determined by GC is about 8% or less. The reactor pressure is then reduced at a rate of 10 Torr per hour to a pressure of 10 Torr, and the reaction is held at 10 Torr until the glycerin content of the polyglycerol component is less than 4%. Once this is achieved, the vacuum is stopped and the reactor is re-pressurized under nitrogen and the reactor is cooled.

Polyglycerol E:

98% USP glycerin, 1% adipic acid, and 1% potassium hydroxide are added to a reactor that was set up with a nitrogen sparge, agitation and a distillation condenser. The reactor is heated to 230° C. with nitrogen sparge. Once 230° C. is reached, the nitrogen sparge is shut off and the reactor is gradually brought down to 250 Torr at a rate of about 75 Torr per hour. When 250 Torr is reached the reaction is monitored via GC until the glycerin content of the polyglycerol component is between 27% and 33%. Then vacuum is walked down to 100 Torr at a rate of 20 Torr per hour to limit the amount of glycerin distillation. The reactor pressure is held at 100 Torr until the glycerin content as determined by GC is about 8% or less. The reactor pressure is then reduced at a rate of 10 Torr per hour to a pressure of 10 Torr, and the reaction is held at 10 Torr until the glycerin content of the polyglycerol component is less than 4%. Once this is achieved, the vacuum is stopped and the reactor is re-pressurized under nitrogen and the reactor is cooled.

Polyglycerol F:

Biodiesel Sourced Glycerin/Glycerin Acetate is loaded into a reactor with a 1.05:1 molar equivalent of potassium hydroxide to acetic acid/ester based on saponification value. The reactor was set up with a nitrogen sparge, agitation and a distillation condenser. The reactor is heated to 230° C. with nitrogen sparge. Once 230° C. is reached, the nitrogen sparge is shut off and the reactor is gradually brought down to 250 Torr at a rate of about 75 Torr per hour. When 250 Torr is reached, the reaction is monitored via GC until the glycerin content of the polyglycerol component is between 27% and 33%. Then vacuum is walked down to 100 Torr at a rate of 20 Torr per hour The reactor pressure is held at 100 Torr until the glycerin content as determined by GC is about 8% or less. The reactor pressure is then reduced at a rate of 10 Torr per hour to a pressure of 10 Torr, and the reaction is held at 10 Torr until the glycerin content of the polyglycerol component is less than 4%. Once this is achieved, the vacuum is stopped and the reactor is re-pressurized under nitrogen and the reactor is cooled.

Note that the component distribution of Polyglycerol F is different from that of Polyglycerol D. Such batch to batch variance is expected in small scale experimental Polyglycerol preparation.

GC Method:

Samples were analyzed using an Agilent 6890 GC with a 30 m DB-5HT column and flame ionization detector (FID) with injector and detector temperatures of 375° C. The oven was initially set to 80° C., then ramped at 10° C./min to 350 and held for 10 minutes. Hydrogen was the carrier gas with flow set at 30 ml/min with air flow of 300 ml/min and nitrogen purge of 30 ml/min and a 20:1 split. Samples were derivatized in pyridine using BSTFA (N,O-Bis(trimethylsilyl)trifluoroacetamide), then further diluted using toluene before injection. Glycerin content of samples is determined by the above described method, using a calibration plot and trimethylolpropane (TMP) as an internal standard.

Chromatographic peak data are integrated and interpreted vs % area assuming all components have the same response factor. Values are based on a % weight. Typical retention times for the components of the polyglycerol composition are presented in Table 2:

TABLE 2

| | Typical Retention Time |
|---|---|
| Component | (min) |
| Glycerin | 7-8 |
| Dicyclic | 11-12 |
| glycerin | |
| diglycerin | 14-15 |
| Tricyclic | 17-18 |
| glycerin | |
| triglycerin | 18-19 |
| tetraglycerin | 21-23 |
| pentaglycerin | 24-26 |
| hexaglycerin | 27-28 |
| Heptaglycerin | 29-30 |
| Octylglycerin | 31-32 |
| Nonaglycerin | 33-34 |

It will be understood that retention times can shift from instrument to instrument based on slight variations on GC flows and pressures.

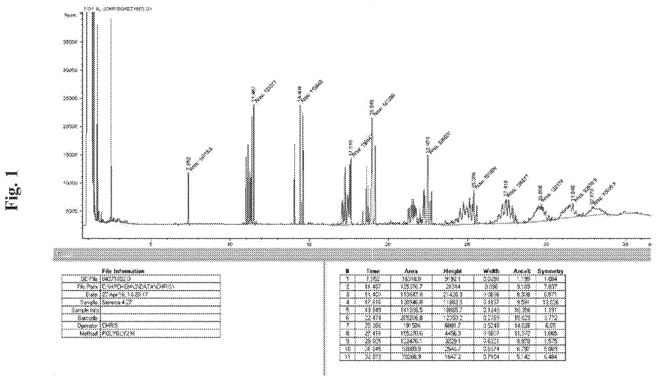

FIG. 1 is a GC chromatogram of Polyglycerol D. The calculated component distribution of the average of the distributions of Polyglycerol D and Polyglycerol F is shown in Table 3:

TABLE 3

| Component | % |
|---|---|
| Glycerin | 2.35 |
| Dicyclic | 11.05 |
| glycerin | |
| diglycerin | 8.1 |
| Tricyclic | 8.35 |
| glycerin | |
| triglycerin | 10.05 |
| tetraglycerin | 14.5 |
| pentaglycerin | 12.9 |
| hexaglycerin | 10.45 |
| Hepta + glycerin | 22.3 |

II. Polyitaconic Acid Syntheses:

700 g of itaconic acid and 632 g of de-ionized water were placed in a 5 L 4 neck flask, equipped with a mechanical mixer, nitrogen inlet and outlet, a condenser, and a thermos-controller. 29.4 g of 50% Sodium hydroxide solution was added slowly to the mixture while agitating. The mixture was heated to 78 to 80° C. under nitrogen until all solid dissolved in a water. A 14 g of potassium persulfate was weighed, and added to the mixture in 3 portions (4.67 g at each dosage) every 90 minutes. The mixture was mixed vigorously maintaining the temperature between 77-80° C. for 20-22 hours. The mixture was stirred at 83° C. for additional 2 to 4 hours. The mixture was cooling down to room temperature in air. Agitator stopped when the mixture temperature reached to 50 to 60° C. Titration with 1N NaOH solution indicated that 68% of Carboxylic Acid remained on the polymer. Mw˜14,000; 49.98% DS (Mettlor, 130° C.) Viscosity (23° C., S5, 100 rpm) 2300 cp.

III Binder Composition Sample Preparation

Binder Samples are prepared by mixing components in dry-weight ratios as set forth in Table 4 below:

The specific manner of preparing these binder examples are described as follows:

Example 1: 237.9 g of 46% Polyacrylic acid (Acumer9932, DOW) and 85.1 g of 50% Polyglycerol C were mixed using a mechanical mixer in a 1 L beaker. To the mixture, 17.8 g of 45% Sodium hypophosphite was added. Water (59.2 g) was added to adjust the final DS content to 40% in a solution.

Example 2, Example 3, and Example 5 were prepared following the same procedure that was used for an Experiment 1 above, except the amounts of ingredients added were as shown in Table 4.

Example 6 and Example 7 followed the same procedure as Example 2, except using a Polyglycerol D and Polyglycerol E, respectively, instead of Polyglycerol C.

Example 4: 156.5 g of 46% Polyacrylic acid (Acumer9932, DOW) and 144 g of 50% Polyglycerol C were mixed using a mechanical mixer in a 1 L beaker. To the mixture, 17.8 g of 45% Sodium hypophosphite was added. A 50% aqueous phosphoric acid (16 g) was added to the mixture. Water (65.7 g) was added to adjust the final DS content to 40% in a solution.

Example 8: 160.4 g of 46% Polyacrylic acid (Acumer9932, DOW) and 147.6 g of 50% Polyglycerol C were mixed using a mechanical mixer in a 1 L beaker. To the mixture, 50% aqueous citric acid solution (8.9 g) and 17.8 g of 45% Sodium hypophosphite was added. Water (65.4 g) was added to adjust the final DS content to 40% in a solution.

Example 8a 220.5 g of 46% Polyacrylic acid (Acumer9932, DOW), 41.36 g of water, and 101.4 g of 100% Polyglycerol C were mixed using a mechanical mixer in a 1 L beaker. To the mixture, 50% aqueous citric acid solution (12.23 g) and 24.44 g of 45% Sodium hypophosphite was added. pH 3, Brookfield Viscosity (DS: 55%, 22° C., 100 rpm, S3): 320 cP.

Example 9, Example 10, and Example 11 followed same procedure with an Example 8 except using a Polyglycerol D, Polyglycerol E, and Polyglycerol B, respectively.

Example 12: 147.6 g of 50% Polyitaconic acid and 147.6 g of 50% Polyglycerol C were mixed using a mechanical mixer in a 1 L beaker. To the mixture, 50% aqueous citric acid solution (8.9 g) and 17.8 g of 45% Sodium hypophosphite was added. Water (78.2 g) was added to adjust the final solid to 40% in a solution.

Example 12a 202.9 g of 50% Polyitaconic acid, 59.0 g of water, and 101.4 g of 100% Polyglycerol C were mixed using a mechanical mixer in a 1 L beaker. To the mixture, 50% aqueous citric acid solution (12.23 g) and 24.44 g of 45% Sodium hypophosphite was added. pH 3, Brookfield Viscosity (DS: 55%, 22° C., 100 rpm, S3): 300 cP.

Example 13: 152 g of 50% citric acid and 152 g of 50% Polyglycerol C were mixed using a mechanical mixer in a 1 L beaker. To the mixture, a 45% Sodium hypophosphite (17.8 g) was added. Water (78.2 g) was added to adjust the final solid to 40% in a solution.

Example 13a 209 g of 50% Citric acid solution, 62.1 g of water, and 104.5 g of 100% Polyglycerol C were mixed using a mechanical mixer in a 1 L beaker. To the mixture, 24.44 g of 45% Sodium hypophosphite was added. pH˜2, Brookfield Viscosity (DS: 55%, 22° C., 100 rpm, S2): 70 cP.

TABLE 4

| Example | 1 | 2 | 3 | 4 | 5 | 6 | 7 | 8 | 9 | 10 | 11 | 12 | 13 |
|---|---|---|---|---|---|---|---|---|---|---|---|---|---|
| Actual | 0.5 | 0.86 | 1.28 | 1.28 | 1.93 | 0.72 | 0.62 | 1.20 | 1.01 | 0.87 | 1.24 | 1.56 | 1.14 |
| [OH]/[CO₂H] | | | | | | | | | | | | | |
| Ingredient | % dry weight in a binder | | | | | | | | | | | | |
| % Poly(acrylic acid) | 68.4 | 57 | 47.5 | 45 | 38 | 57 | 57 | 46.11 | 46.11 | 46.11 | 46.11 | | |
| % Poly(Itaconic acid) | | | | | | | | | | | | 46.11 | |
| % Citric Acid | | | | | | | | 2.78 | 2.78 | 2.78 | 2.78 | 2.78 | 47.5 |
| % Phosphoric acid | | | | 5 | | | | | | | | | |
| % Polyglycerol B | | | | | | | | | | | 46.11 | | |
| % Polyglycerol C | 26.6 | 38 | 47.5 | 45 | 57 | | | 46.11 | | | | 46.11 | |
| % Polyglycerol D | | | | | | 38 | | | 46.11 | | | | 47.5 |
| % Polyglycerol E | | | | | | | 38 | | | 46.11 | | | |
| % SHP (sodium | 5 | 5 | 5 | 5 | 5 | 5 | 5 | 5 | 5 | 5 | 5 | 5 | 5 |
| hypophosphite) | | | | | | | | | | | | | |
| SUM | 100 | 100 | 100 | 100 | 100 | 100 | 100 | 100 | 100 | 100 | 100 | 100 | 100 |

Stated a different way, the 40% Binder Samples are prepared by mixing components in As-is weight ratios as set forth in Table 5 below.

TABLE 5

| Example | 1 | 2 | 3 | 4 | 5 | 6 | 7 | 8 | 9 | 10 | 11 | 12 | 13 |
|---|---|---|---|---|---|---|---|---|---|---|---|---|---|
| Actual | 0.5 | 0.86 | 1.28 | 1.28 | 1.93 | 0.72 | 0.62 | 1.2 | 1.01 | 0.87 | 1.24 | 1.56 | 1.14 |
| [OH]/[CO2H] | | | | | | | | | | | | | |
| Ingredient | Weight (g) | | | | | | | | | | | | |
| 46% Poly(acrylic | 237.9 | 198.3 | 165.2 | 156.5 | 132.2 | 198.3 | 198.3 | 160.4 | 160.4 | 160.4 | 160.4 | | |
| acid) | | | | | | | | | | | | | |
| 50% Poly(Itaconic | | | | | | | | | | | | 147.6 | |
| acid) | | | | | | | | | | | | | |
| 50% Citric Acid | | | | | | | | 8.9 | 8.9 | 8.9 | 8.9 | 8.9 | 152 |
| 50% Phosphoric | | | | 16 | | | | | | | | | |
| acid | | | | | | | | | | | | | |
| 50% Polyglycerol | | | | | | | | | | | 147.6 | | |
| B | | | | | | | | | | | | | |
| 50% Polyglycerol | 85.12 | 121.6 | 152 | 144 | 182.4 | | | 147.6 | | | | 147.6 | 152 |
| C | | | | | | | | | | | | | |
| 50% Polyglycerol | | | | | | 121.6 | | | 147.6 | | | | |
| D | | | | | | | | | | | | | |
| 50% Polyglycerol | | | | | | | 121.6 | | | 147.6 | | | |
| E | | | | | | | | | | | | | |
| 45% SHP | 17.8 | 17.8 | 17.8 | 17.8 | 17.8 | 17.8 | 17.8 | 17.8 | 17.8 | 17.8 | 17.8 | 17.8 | 17.8 |
| Water | 59.2 | 62.4 | 65 | 65.7 | 67.7 | 62.4 | 62.4 | 65.4 | 65.4 | 65.4 | 65.4 | 78.2 | 78.2 |
| SUM | 400 | 400 | 400 | 400 | 400 | 400 | 400 | 400 | 400 | 400 | 400 | 400 | 400 |

III-a Properties of Films Prepared Using Example 8a, 12a, and 13a

Films were prepared from the compositions of Example 8a, 12a, and 13a according to the following methods:

A 2.9 g of 55% Example 8a solution (Dry weight 1.6 g) was placed in a pre-weighed aluminum dish (7.4 cm diameter×1.4 cm height). The weight of the sample was recorded. To help to spread out the sample in a dish evenly, water was added to the sample to the weight of approximately 15.0 gram. The mixture was swirled to mix. Example 12a and 13a samples were prepared using the same method. Samples were cured at the 130° C. for 2 hours and 210° C. for 6 minutes. After curing, the samples were weighed to estimate the weight loss in curing process. For the water/humidity resistance test, water was added to the film in a dish to soak the film overnight. For a thermal stability test, the cured sample was held at a temperature of 120° C. for 16 hours and 210° C. for 10 min. The cured sample was peeled off from the aluminum dish, and the film was weighed. The weighed film was placed in an oven pre-set at 280° C. for 30 min. After cooling, the sample was weighed again. The film color change was also monitored.

The resulting properties are as reported in Table 6 below:

TABLE 6

| | Example 13a | Example 12a | Example 8a |
|---|---|---|---|
| Maximum % Solid of Binder (Theoretical) | 72% | 65% | 63% |
| Viscosity (55% Solid, 100 rpm, 22° C.) | 70 cP | 300 cP | 320 cP |
| Color after Curing at the 250° C. | Dark Brown | Brown | Pale yellow |
| Weight Loss after curing at the 130° C. for 16 hours | 5% | 6% | 5% |
| Weight Loss after curing at the 120° C. for 16 hours, | 20% | 11% | 7% |
| then 210° C. for 10 minutes | | | |
| Water/Humidity Resistance of film | Good | Better | Best |
| Tensile strength of Mat with the binder | Good | Better | Best |
| pH of the binder | ~2 | ~3 | ~3 |
| % Renewable source | ~90% | ~90% | ~50% |
| Thermal Stability of Cured film (Mass Change after | ~15% loss | Not measured | 1% or less |
| heating for 30 minutes at 280° C. | | | |
| Thermal Stability of Cured film (Color Change after | Very dark | Dark Brown | Pale brown |
| heating for 30 minutes at 280° C. | | | |

III-b Tensile Strength of Binders with Polyglycerol C and Various Poly(Carboxylic Acids)

The tensile properties of films prepared from the binder compositions of Examples 8a, 12a and 13a were tested by curing the binder with a SHP catalyst on a glass mat. Mats prepared using the indicated binder samples were cured in first curing process at 132° C. for 15 minutes, followed by a second curing process at 130° C. for 60 minutes.

Tensile Strength Tests were carried out at ambient temperature (room temperature ˜24° C.) and at 95° C.˜100° C. for hot tensile strength.

The testing process is described below.

A pre-weighed fiberglass-mat (˜19 cm×2.6 cm×0.45 mm, straight rectangle strip, density 113 Kg/m³) was placed in a binder solution to soak in. The binder solution (55% DS) was diluted with a water stepwise in order to obtain the desired cure weight of binder on a mat. While immersing the glass sheet in a solution, light pressure was applied to the glass sheet using a hand roller to help to remove trapped air from the fiberglass-mat, helping the binder to soak into the glass sheet evenly. The wet glass sheet was then moved from the solution carefully out to the flat area in the tray. Then, light pressure was applied on the wet fiberglass mat evenly using a hand roller to squeeze out excess binder. The mat was placed on a stack of two blotter papers. Two additional blotter papers were placed to cover the sample. Pressure was applied by rolling a papermaker's hand roller (28 lbs.) two times back and forth on the blotter paper covering a mat. The dewatered mat was placed on speed dryer set at a temperature of 120-140° C. for 15 minutes for the first curing. Samples were placed in an oven at a temperature of 120° C. for 1 hour for the second curing. The dried sample was cooled to room temperature in a desiccator. Sample was then weighed to estimate the amount of binder on the mat. Samples were equilibrated at a TAPPI standard condition for at least for 24 hours (temperature 22° C., % RH˜50%) before tensile strength test. Before the test, the mat sample was cut in half, and tensile strength of both halves was measured. Data from measurement of the halves of each sample are averaged to get a tensile strength for a sample. Tensile strength testing was carried out at the ambient temperature (22-25° C., RH˜50%) using an Instron testing device (Model 5943, 11th, rate 20 mm/min). Standard pneumatic side-action grips were used. A sample was placed between the upper grips and bottom grips, set at the 3 cm apart. The grips were engaged to hold the sample by applying air pressure to the grips. Gripping strength was adjusted by supplying air pressure. For the test, the air pressure to the grips was applied at 50 psi. Tensile was measured by causing the upper grips to move at a travel speed of 20 mm/min. until the observed measured load drops 20 N.

For hot tensile measurement, glass sheet samples were heated to 95-105° C. Heating of sample was carried out using a heat gun (Model 0283278, 1680 W, Wagner Spray Tech. Corp.) held at a distance of 11.5 inches from the sample. The temperature of the sample was estimated using a thermo-couple sitting at the opposite side of glass-sheet sample surface and front side of sheet sample surface. The sample was exposed to the heat stream for 90 seconds. It took approximately 30 seconds for the sample surface to reach a temperature of 90° C., and another 30 seconds to reach to constant temperature at the sample surface (estimated 95-105° C.). Mat samples measured before application of the binder (i.e. a control mat) exhibited an average maximum load 65.0 N with a standard deviation (SD) of 3.07 N at the room temperature (23° C.) and 44.9 N (SD 1.40 N) at the elevated temperature (˜100° C.).

Test results are provided in Table 7 and 8, which indicated that a polyglycerol based binder comprising a polymer of polycarboxylic acids provided better tensile strength to the fiberglass mat than a polyglycerol binder comprising a monomeric polycarboxylic acid.

TABLE 7
Tensile Strength at the room temperature (23° C.)

| Example 8a | | Example 12a | | Example 13a | |
|---|---|---|---|---|---|
| % Weight | | | Max | | max |
| (Wt.) of | Max Load | % Wt. of | Load | % Wt. of | Load |
| Binder | (N) | Binder | (N) | Binder | (N) |
| 7.0% | 86.53 | 7.5% | 80.26 | 6.7% | 62.96 |
| 7.4% | 89.41 | 7.6% | 84.20 | 7.5% | 78.45 |
| 7.4% | 82.15 | 7.9% | 78.76 | 7.9% | 81.78 |
| 7.9% | 83.63 | 7.9% | 79.77 | 8.2% | 73.82 |
| 8.6% | 91.95 | 8.1% | 80.03 | 8.2% | 67.47 |
| 8.8% | 96.55 | 8.2% | 80.45 | 8.2% | 69.36 |
| 9.3% | 85.41 | 8.3% | 83.33 | 8.8% | 73.82 |
| 9.5% | 94.34 | 8.4% | 74.48 | 9.1% | 70.70 |
| 9.5% | 95.33 | 8.7% | 81.35 | 9.4% | 79.88 |
| 9.8% | 96.29 | 9.0% | 85.38 | 9.5% | 75.97 |
| 9.9% | 84.01 | 9.3% | 85.94 | 9.5% | 78.84 |
| 10.3% | 86.72 | 9.7% | 79.50 | 9.7% | 73.93 |
| 10.5% | 92.58 | 9.8% | 84.38 | 9.7% | 79.04 |
| 10.9% | 93.92 | 10.2% | 84.92 | 10.1% | 62.96 |
| 11.2% | 94.35 | 10.5% | 83.76 | 10.1% | 77.11 |
| 11.7% | 98.88 | 10.5% | 80.33 | 10.2% | 79.89 |
| 11.9% | 100.63 | 10.8% | 77.47 | 10.3% | 82.32 |
| 12.1% | 96.14 | 10.9% | 84.63 | 10.5% | 73.56 |
| 12.2% | 92.12 | 11.1% | 87.59 | 10.6% | 67.88 |
| 12.7% | 96.04 | 11.5% | 83.40 | 11.0% | 73.56 |
| 12.9% | 101.83 | 12.3% | 89.84 | 11.0% | 74.71 |
| 13.1% | 101.05 | 12.4% | 79.27 | 11.9% | 86.62 |
| 13.6% | 97.90 | 12.9% | 87.44 | 12.2% | 87.73 |
| 14.1% | 96.51 | 13.6% | 87.04 | 13.4% | 87.61 |
| 14.3% | 82.73 | 14.4% | 79.45 | 14.3% | 84.21 |

TABLE 8
Tensile Strength at the elevated temperature (100° C.)

| Example 8a | | Example 12a | | Example 13a | |
|---|---|---|---|---|---|
| % Wt. of | Max Load | % Wt. of | Max Load | % Wt. of | max Load |
| Binder | (N) | Binder | (N) | Binder | (N) |
| 7.0% | 62.82 | 7.0% | 64.52 | 6.7% | 47.30 |
| 7.9% | 66.55 | 7.5% | 62.46 | 7.3% | 49.34 |
| 8.8% | 67.45 | 7.6% | 71.62 | 7.8% | 49.68 |
| 8.9% | 74.27 | 7.9% | 71.14 | 8.0% | 47.93 |
| 9.2% | 59.41 | 8.3% | 66.48 | 8.3% | 48.49 |
| 9.3% | 68.21 | 8.5% | 64.20 | 9.0% | 46.85 |
| 9.4% | 69.81 | 8.7% | 64.02 | 9.1% | 51.76 |
| 9.6% | 67.45 | 9.1% | 72.65 | 9.3% | 48.73 |
| 10.3% | 71.40 | 9.2% | 63.48 | 9.8% | 52.41 |
| 10.9% | 60.07 | 10.1% | 73.31 | 9.9% | 46.51 |
| 11.2% | 72.80 | 10.6% | 73.28 | 10.2% | 52.22 |
| 11.9% | 70.71 | 10.9% | 71.57 | 10.7% | 50.64 |
| 12.6% | 69.79 | 11.0% | 68.98 | 11.7% | 53.26 |
| 12.7% | 66.70 | 11.1% | 74.03 | 12.3% | 52.50 |
| 13.2% | 74.94 | 11.7% | 68.19 | 13.9% | 52.52 |
| 13.9% | 69.03 | 12.2% | 72.46 | | |
| 14.6% | 72.67 | 13.6% | 70.66 | | |

III-c Tensile Strength of Example 1, 2, 3, and 5 Prepared with a Polyglycerol C and a Poly(Acrylic Acid) at the Various Mixing Ratio.

Binder samples were prepared using a polyacrylic acid (Acumer 9932) and a polyglycerol C from 3:7, 4:6, 5:5, and 6:4 by dry weight. Tensile strength test process is described at section III-b. The initial binder solutions (40% DS) were diluted stepwise in order to get the desired cured binder weight on the mat. The test data in Tables 9 and 10 indicate that the ratio of a polyglycerol and a polycarboxylic acid is an important factor in tensile strength of test mats comprising the present binder after curing.

TABLE 9
Tensile Strength at the room temperature (23° C.)

| Example 1 | | Example 2 | | Example 3 | | Example 5 | |
|---|---|---|---|---|---|---|---|
| % Wt. | Max | % Wt. | Max | % Wt. | max | % Wt. | max |
| of | Load | of | Load | of | Load | of | Load |
| Binder | (N) | Binder | (N) | Binder | (N) | Binder | (N) |
| 6.7% | 100.50 | 6.6% | 99.66 | 6.9% | 91.56 | 6.3% | 88.22 |
| 7.4% | 103.22 | 7.8% | 101.29 | 7.6% | 97.78 | 6.7% | 83.87 |
| 8.4% | 105.10 | 8.2% | 104.03 | 8.0% | 110.28 | 6.8% | 90.06 |
| 8.4% | 107.88 | 8.4% | 102.24 | 8.2% | 96.15 | 7.8% | 90.41 |
| 8.5% | 105.06 | 8.7% | 105.82 | 8.8% | 102.34 | 9.0% | 98.29 |
| 8.6% | 106.99 | 9.5% | 104.84 | 9.0% | 104.73 | 9.2% | 94.57 |
| 8.7% | 101.63 | 9.7% | 100.21 | 9.4% | 107.14 | 9.6% | 91.83 |
| 8.7% | 105.84 | 10.1% | 105.21 | 9.9% | 106.59 | 9.9% | 94.42 |
| 8.7% | 101.79 | 10.1% | 104.83 | 10.2% | 113.40 | 10.1% | 93.50 |
| 8.9% | 103.09 | 10.7% | 108.56 | 10.3% | 99.80 | 10.5% | 96.91 |
| 9.3% | 100.54 | 11.8% | 108.36 | 10.8% | 102.49 | 11.3% | 100.66 |
| 9.6% | 107.87 | | | 11.5% | 109.27 | | |
| 9.7% | 110.37 | | | | | | |
| 10.1% | 101.13 | | | | | | |

TABLE 10
Tensile Strength at the elevated temperature (100° C.)

| Example 1 | | Example 2 | | Example 3 | | Example 5 | |
|---|---|---|---|---|---|---|---|
| % Wt. | Max | % Wt. | Max | % Wt. | max | % Wt. | max |
| of | Load | of | Load | of | Load | of | Load |
| Binder | (N) | Binder | (N) | Binder | (N) | Binder | (N) |
| 6.9% | 78.53 | 7.2% | 75.73 | 7.7% | 66.00 | 6.7% | 57.75 |
| 8.2% | 84.78 | 7.8% | 79.08 | 8.1% | 69.56 | 6.8% | 55.88 |
| 8.6% | 85.71 | 8.2% | 79.47 | 8.3% | 74.09 | 8.5% | 67.43 |
| 8.8% | 92.10 | 8.7% | 78.66 | 8.9% | 72.40 | 9.2% | 67.33 |
| 8.9% | 87.23 | 9.3% | 86.83 | 9.1% | 76.11 | 9.5% | 66.26 |
| 9.2% | 85.63 | 9.7% | 84.90 | 9.6% | 72.83 | 9.9% | 56.79 |
| 9.5% | 88.98 | 9.9% | 84.78 | 10.0% | 71.95 | 10.5% | 60.49 |
| 9.8% | 83.73 | 10.1% | 92.08 | 10.2% | 78.59 | 11.2% | 61.32 |
| 10.5% | 93.63 | 10.4% | 82.15 | | | | |
| | | 11.1% | 79.81 | | | | |
| | | 11.6% | 88.59 | | | | |

III-d Tensile Strength of Binders with Various Polyglycerols B, C, D, and E and a Poly(Acrylic Acid)

Various polyglycerols were selected to mix with a polyacrylic acid to see if the composition difference of the polyglycerol impacts the binder performance. Test results are presented in Tables 11 and 12. Tensile strength test process is described at section III-c. The initial binder solutions (40% DS) were diluted stepwise in order to get the desired cured binder weight on the mat. Example 9 showed best performance in tensile strength. Example 9 showed its tensile strength about 20% higher than the Example 8. Example 10 showed about 10% enhancement in its tensile strength compare to Example 8. Example 8 and Example 11 exhibited tensile strength values that are similar to each other.

TABLE 11
Tensile Strength at the room temperature (23° C.)

| Example 8 | | Example 9 | | Example 10 | | Example 11 | |
|---|---|---|---|---|---|---|---|
| % Wt. | Max | % Wt. | Max | % Wt. | max | % Wt. | max |
| of | Load | of | Load | of | Load | of | Load |
| Binder | (N) | Binder | (N) | Binder | (N) | Binder | (N) |
| 8.1% | 99.2 | 6.0% | 109.4 | 6.6% | 100.7 | 6.1% | 90.5 |
| 8.9% | 97.5 | 7.1% | 108.6 | 7.9% | 98.2 | 7.0% | 92.1 |
| 8.9% | 96.4 | 7.1% | 108.4 | 8.1% | 106.2 | 7.2% | 87.2 |
| 9.4% | 88.2 | 7.5% | 114.2 | 8.6% | 103.5 | 7.2% | 92.0 |
| 9.7% | 99.4 | 8.0% | 107.2 | 8.7% | 105.5 | 7.8% | 97.6 |
| 10.3% | 95.1 | 8.3% | 114.3 | 8.7% | 107.0 | 7.9% | 91.2 |
| 10.3% | 94.2 | 8.8% | 109.9 | 9.3% | 104.6 | 8.5% | 89.2 |
| 10.5% | 101.8 | 8.8% | 120.6 | 9.3% | 106.0 | 9.1% | 93.7 |
| 10.9% | 96.7 | 9.5% | 110.6 | 9.3% | 112.5 | 9.6% | 100.0 |
| 10.9% | 99.3 | 9.7% | 113.6 | 10.1% | 103.4 | 9.9% | 99.2 |
| 11.1% | 97.7 | 9.8% | 110.3 | 11.0% | 115.6 | 10.6% | 99.8 |
| 11.8% | 91.2 | 10.2% | 116.3 | 11.9% | 101.6 | 11.0% | 93.4 |
| 12.4% | 100.0 | 10.2% | 115.8 | 12.0% | 109.3 | 11.1% | 98.9 |
| | | 11.0% | 120.2 | | | 11.9% | 94.9 |
| | | 11.5% | 119.9 | | | 11.9% | 99.7 |

TABLE 12
Tensile Strength at the elevated temperature (100° C.)

| Example 8 | | Example 9 | | Example 10 | | Example 11 | |
|---|---|---|---|---|---|---|---|
| % Wt. | Max | % Wt. | Max | % Wt. | max | % Wt. | max |
| of | Load | of | Load | of | Load | of | Load |
| Binder | (N) | Binder | (N) | Binder | (N) | Binder | (N) |
| 7.7% | 83.9 | 7.3% | 92.1 | 7.7% | 90.8 | 7.3% | 85.2 |
| 8.4% | 84.8 | 7.4% | 93.5 | 8.3% | 86.8 | 7.4% | 85.1 |
| 8.4% | 87.6 | 8.2% | 96.0 | 9.0% | 89.3 | 7.7% | 81.9 |
| 9.1% | 85.3 | 8.5% | 92.2 | 9.1% | 92.4 | 7.9% | 86.4 |
| 9.8% | 85.2 | 8.9% | 96.9 | 9.1% | 88.0 | 9.5% | 88.5 |
| 10.2% | 87.5 | 9.1% | 97.3 | 9.7% | 96.1 | 9.5% | 85.7 |
| 10.7% | 92.6 | 9.3% | 92.5 | 10.3% | 93.8 | 10.6% | 82.9 |
| 10.7% | 86.6 | 10.1% | 95.7 | 10.8% | 102.1 | 11.3% | 91.9 |
| 11.4% | 87.6 | 10.6% | 103.6 | 11.8% | 97.1 | 11.7% | 93.9 |
| 12.2% | 88.0 | 11.4% | 98.7 | 12.1% | 90.6 | 12.1% | 95.9 |

When samples were exposed to the humidity chamber set at RH=100% and temperature 35-40° C., the tensile strength tends to drop somewhat. The data is listed in Table 13. Among these samples, Example 9 showed the highest tensile strength in a wet condition. Example 8 and Example 11 showed similar dry strength with each other, but the Example 11 showed poorer wet strength than Example 8.

TABLE 13
wet-Tensile Strength (RH = 100%, 35-40° C., 2 hours)

| Example 8 | | Example 9 | | Example 10 | | Example 11 | |
|---|---|---|---|---|---|---|---|
| % Wt. | Max | % Wt. | Max | % Wt. | max | % Wt. | max |
| of | Load | of | Load | of | Load | of | Load |
| Binder | (N) | Binder | (N) | Binder | (N) | Binder | (N) |
| 7.2% | 87.05 | 7.2% | 90.26 | 6.5% | 78.28 | 6.9% | 66.05 |
| 7.3% | 78.36 | 7.3% | 101.82 | 8.1% | 90.39 | 7.0% | 71.49 |
| 7.8% | 90.62 | 7.5% | 98.60 | 8.5% | 82.99 | 7.2% | 68.53 |
| 7.8% | 88.59 | 7.8% | 88.99 | 8.5% | 83.47 | 7.3% | 72.10 |
| 7.9% | 82.98 | 8.5% | 97.13 | 9.0% | 82.81 | 7.4% | 66.56 |
| 8.6% | 79.23 | 8.5% | 97.27 | 9.4% | 75.75 | 8.7% | 60.79 |
| 9.2% | 76.57 | 9.4% | 95.99 | 9.5% | 85.42 | 9.3% | 61.51 |
| 9.4% | 85.09 | 9.4% | 90.47 | 9.5% | 88.63 | 9.4% | 59.77 |
| 10.4% | 83.01 | 9.5% | 95.31 | 10.3% | 85.64 | 10.2% | 61.66 |
| 10.4% | 77.02 | 10.1% | 98.58 | 11.2% | 93.59 | 10.4% | 61.04 |
| 10.9% | 86.97 | 10.1% | 102.51 | 11.5% | 76.86 | 11.0% | 57.42 |
| 11.0% | 78.51 | 11.1% | 101.49 | 11.8% | 79.40 | 11.6% | 64.82 |
| 11.3% | 82.34 | 12.2% | 97.38 | | | 12.2% | 58.25 |
| 11.8% | 85.40 | | | | | | |
| 12.1% | 84.09 | | | | | | |

III-e Tensile Strength Recovery Properties of Binders with Polyglycerol C and a Poly(Acrylic Acid)

Tensile strength test process is described at section III-c. The initial binder solutions (40% DS) were diluted stepwise in order to get the desired cured binder weight on the mat. Mat samples prepared using the binders of Example 2 and Example 3 were kept in a humidity chamber set at RH=100% (saturated) at the 80° C. for 20 minutes. Wet mat samples were placed in the lab bench for 20 minutes. Samples were submitted for the tensile test immediately. The results were listed in Table 14.

TABLE 14
Tensile strength of wet mat sample after air-drying in a room condition

| Example 2 | | Example 2 | | Example 3 | | Example 3 | |
|---|---|---|---|---|---|---|---|
| (RT) | | (Treated*) | | (RT) | | (Treated*) | |
| % Wt | Max | % Wt | Max | % Wt | max | % Wt | max |
| of | Load | of | Load | of | Load | of | Load |
| Binder | (N) | Binder | (N) | Binder | (N) | Binder | (N) |
| 6.6% | 99.66 | 8.2% | 102.90 | 6.9% | 91.56 | 7.0% | 99.60 |
| 7.8% | 101.29 | 8.3% | 103.41 | 7.6% | 97.78 | 7.5% | 101.62 |
| 8.2% | 104.03 | 9.0% | 104.68 | 8.0% | 110.28 | 8.1% | 98.49 |
| 8.4% | 102.24 | 9.3% | 105.66 | 8.2% | 96.15 | 8.6% | 110.79 |
| 8.7% | 105.82 | 9.7% | 101.57 | 8.8% | 102.34 | 8.9% | 108.55 |
| 9.5% | 104.84 | 9.9% | 110.76 | 9.0% | 104.73 | 9.3% | 96.84 |
| 9.7% | 100.21 | 10.2% | 104.47 | 9.4% | 107.14 | 9.8% | 115.15 |
| 10.1% | 105.21 | 10.5% | 113.00 | 9.9% | 106.59 | | |
| 10.1% | 104.83 | 11.5% | 99.36 | 10.2% | 113.40 | | |
| 10.7% | 108.56 | | | 10.3% | 99.80 | | |
| 11.8% | 108.36 | | | 10.8% | 102.49 | | |
| | | | | 11.5% | 109.27 | | |

*Treated sample - Dried wet mat samples in the air at the RT for 20 minutes after hot humid treatment for 20 minutes. (RH = 100%, 80° C.)

As used herein, the terms “about” or “approximately” mean within an acceptable range for the particular parameter specified as determined by one of ordinary skill in the art, which will depend in part on how the value is measured or determined, e.g., the limitations of the sample preparation and measurement system. Examples of such limitations include preparing the sample in a wet versus a dry environment, different instruments, variations in sample height, and differing requirements in signal-to-noise ratios. For example, “about” can mean greater or lesser than the value or range of values stated by 1/10 of the stated values, but is not intended to limit any value or range of values to only this broader definition. For instance, a concentration value of about 30% means a concentration between 27% and 33%. Each value or range of values preceded by the term “about” is also intended to encompass the embodiment of the stated absolute value or range of values. Alternatively, particularly with respect to biological systems or processes, the term can mean within an order of magnitude, preferably within 5-fold, and more preferably within 2-fold, of a value.

Throughout this specification and claims, unless the context requires otherwise, the word “comprise”, and variations such as “comprises” and “comprising”, will be understood to imply the inclusion of a stated integer or step or group of integers or steps but not the exclusion of any other integer or step or group of integer or step. When used herein “consisting of” excludes any element, step, or ingredient not specified in the claim element. When used herein, “consisting essentially of” does not exclude materials or steps that do not materially affect the basic and novel characteristics of the claim. In the present disclosure of various embodiments, any of the terms “comprising”, “consisting essentially of” and “consisting of” used in the description of an embodiment may be replaced with either of the other two terms.

All patents, patent applications (including provisional applications), and publications cited herein are incorporated by reference as if individually incorporated for all purposes. Unless otherwise indicated, all parts and percentages are by weight and all molecular weights are weight average molecular weights. The foregoing detailed description has been given for clarity of understanding only. No unnecessary limitations are to be understood therefrom. The invention is not limited to the exact details shown and described, for variations obvious to one skilled in the art will be included within the invention defined by the claims.

1. An aqueous binder composition for use in the formation of fiber insulation and nonwoven mats comprising water and a reaction product of:
a) a polymeric poly(carboxylic acid) component; and
b) a polyglycerol component;
wherein
the dry weight ratio of poly(carboxylic acid) to polyglycerol is from about 70:30 to about 40:60,
the binder composition comprises no more than about 25% by weight of sugar-containing components based on non-water ingredients of the binder composition, and
the polyglycerol component comprises no more than about 15% by weight of monoglycerol based on non-water ingredients of the polyglycerol component.

2.-40. (canceled)

41. The aqueous binder composition of claim 1, wherein the molar ratio of OH/CO₂H is from about 0.6 to about 2.

42. The aqueous binder composition of claim 1, wherein the binder composition comprises no more than about 10% by weight of monoglycerol based on non-water ingredients of the polyglycerol component.

43. The aqueous binder composition of claim 1, wherein the dry weight ratio of poly(carboxylic acid) to polyglycerol component is from about 50:50 to about 40:60.

44. The aqueous binder composition of claim 1, wherein the polymeric poly(carboxylic acid) component comprises a poly(carboxylic acid) selected from the group consisting of one or more of polyacrylic acid, polymethacrylic acid, and polyitaconic acid.

45. The aqueous binder composition of claim 1, wherein the poly(carboxylic acid) component comprises polyacrylic acid.

46. The aqueous binder composition of claim 44, wherein the poly(carboxylic acid) component comprises polyacrylic acid having an average molecular weight of from about 1000 to about 15000; or polyacrylic acid having an average molecular weight of from about 2000 to about 12000.

47. The aqueous binder composition of claim 1, wherein the poly(carboxylic acid) component comprises polymethacrylic acid.

48. The aqueous binder composition of claim 1, wherein the poly(carboxylic acid) component comprises polyitaconic acid.

49. The aqueous binder composition of claim 1, wherein the polyglycerol component has a triglycerol content of from about 15% to about 30% by weight.

50. The aqueous binder composition of claim 1, wherein the polyglycerol component has a combined triglycerol and tetraglycerol content of less than about 70%; or less than about 50%; or less than about 40%; or less than about 35%; or less than about 25%.

51. The aqueous binder composition of claim 1, wherein the polyglycerol component has a combined triglycerol and higher polyglycerol oligomer content of from about 60% to about 95%.

52. The aqueous binder composition of claim 1, wherein the polyglycerol component has a combined tetraglycerol and pentaglycerol oligomer content of from about 50% to about 95%, and a triglycerol content of less than about 12%.

53. The aqueous binder composition of claim 1, wherein the aqueous binder composition further comprises a salt of hypophosphite, phosphate or phosphite.

54. The aqueous binder composition of claim 1, wherein the aqueous binder composition has a viscosity of from 40 cp to 3000 cp at 55% DS at 25° C.

55. A nonwoven product comprising:
a plurality of randomly oriented fibers; and
a binder applied to at least a portion of the fibers, said binder comprising the reaction product of the binder composition of claim 1.

56. The nonwoven product of claim 55, wherein the nonwoven product has a density of from about 16 to about 300 Kg/m³.

57. The nonwoven product of claim 55, wherein the nonwoven product has a density of about less than 16 Kg/cm³.
